(19) United States
(12) Patent Application Publication
(10) Pub. No.: US 2023/0405832 A1
(43) Pub. Date: Dec. 21, 2023

(54) VEHICLE, METHOD, AND PROGRAM

(71) Applicant: TOYOTA JIDOSHA KABUSHIKI KAISHA, Toyota-shi Aichi-ken (JP)

(72) Inventors: Masatoshi HAYASHI, Nisshin-shi (JP); Josuke Yamane, Nagoya-shi (JP); Daigo Fujii, Nagoya-shi (JP); Yuki Tatsumoto, Seto-shi Aichi-ken (JP); Takurou Sakai, Setagaya-ku Tokyo (JP)

(73) Assignee: TOYOTA JIDOSHA KABUSHIKI KAISHA, Toyota-shi Aichi-ken (JP)

(21) Appl. No.: 18/132,645

(22) Filed: Apr. 10, 2023

(30) Foreign Application Priority Data
Jun. 16, 2022 (JP) 2022-097616

(51) Int. Cl. B25J 9/16

(52) U.S. Cl. CPC B25J 9/1697; B25J 9/1679

(57) ABSTRACT

The vehicle includes a control unit that determines whether or not to stack the package based on the package information.

### CROSS-REFERENCE TO RELATED APPLICATION

This application claims priority to Japanese Patent Application No. 2022-097616 filed on Jun. 16, 2022 incorporated herein by reference in its entirety.

### BACKGROUND

### 1. Technical Field

The present disclosure relates to a vehicle, a method, and a program.

### 2. Description of Related Art

Japanese Unexamined Patent Application Publication No. 2020-181287 (JP 2020-181287 A) discloses an autonomous driving delivery system.

### SUMMARY

In the related art, when a single package is left at a delivery point, there is a possibility that a space for the delivery point cannot be sufficiently secured, and another package cannot be left additionally. On the other hand, if a plurality of packages can be left at the delivery point even when the space for the delivery point is insufficient, the efficiency of an unattended delivery service is improved.

An object of the present disclosure made in view of these circumstances is to provide a technique in which the efficiency of the unattended delivery service is improved.

A vehicle according to one embodiment of the present disclosure includes a control unit that determines whether a package is stacked based on package information.

A method according to one embodiment of the present disclosure is a method executed by an information processing device and includes determining whether a package is stacked based on package information.

A program according to one embodiment of the present disclosure causes a computer to execute functions including determining whether a package is stacked based on package information.

According to an embodiment of the present disclosure, it is possible to provide a technique in which the efficiency of the unattended delivery service is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of a vehicle according to an embodiment of the present disclosure;

FIG. 3 is a block diagram illustrating a schematic configuration of an information processing device according to an embodiment of the present disclosure;

FIG. 4 is a flowchart illustrating an operation of a vehicle according to an embodiment of the present disclosure.

### DETAILED DESCRIPTION OF EMBODIMENTS

Hereinafter, an embodiment of the present disclosure will be described.

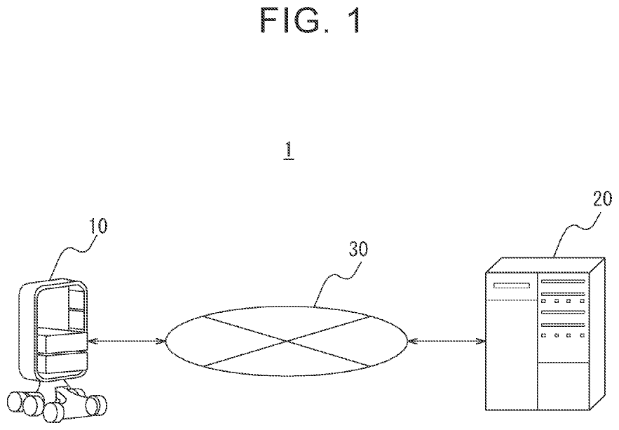

The outline of a system 1 according to an embodiment of the present disclosure will be described with reference to FIG. 1.

The system 1 includes a vehicle 10 and an information processing device 20. The vehicle 10 and the information processing device 20 are communicably connected to the network 30.

The vehicle 10 is an automobile capable of delivering a package to an arbitrary delivery destination, but is not limited thereto, and may be an arbitrary vehicle. Motor vehicles include, but are not limited to, for example, gasoline-powered vehicles, Battery Electric Vehicle (BEV), Hybrid Electric Vehicle (HEV), Plug-in Hybrid Electric Vehicle (PHEN), or Fuel Cell Electric Vehicle (FCEV). The vehicle 10 may be driven by a driver, or the driving may be automated at a desired level. The level of automation is, for example, any of level 1 to level 5 in the level division of Society of Automotive Engineers (SAE).

The information processing device 20 is, for example, a computer such as a server belonging to a cloud computing system or other computing systems.

Network 30 may include the Internet, at least one wide area network (WAN), at least one metropolitan area network (MAN), or any combination thereof. Network 30 may include at least one wireless network, at least one optical network, or any combination thereof. The wireless network is, for example, an ad hoc network, a cellular network, a wireless local area network (wireless LAN), a satellite communication network, or a terrestrial microwave network.

The outline of the present embodiment will be described with reference to FIG. 1. The control unit 11 of the vehicle 10 determines whether or not to stack the cargo based on the package information.

According to the present embodiment, when the load is stacked even when the space of the delivery point is insufficient, a plurality of loads can be placed at the delivery point. Therefore, the efficiency of the placement can be improved.

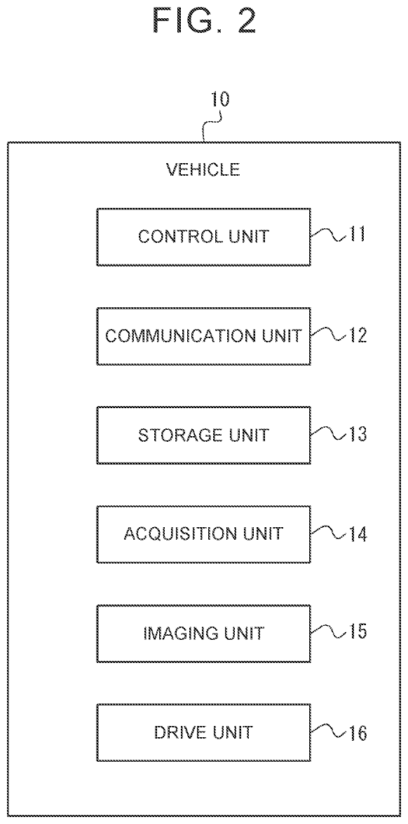

The configuration of the vehicle 10 according to the present embodiment will be described with reference to FIG. 2.

The vehicle 10 includes a control unit 11, a communication unit 12, a storage unit 13, an acquisition unit 14, an imaging unit 15, and a drive unit 16.

The control unit 11 includes at least one processor, at least one programmable circuit, at least one dedicated circuit, or any combination thereof. A processor is a general-purpose processor such as central processing unit (CPU) or graphics processing unit (GPU), or a special-purpose processor specialized for a particular process. The programmable circuitry is, for example, field-programmable gate array (FPGA). The dedicated circuitry is, for example, application specific integrated circuit (ASIC). The control unit 11 executes processes related to the operation of the vehicle 10 while controlling each unit of the vehicle 10.

The communication unit 12 includes at least one communication interface. The communication interface is, for example, an interface compliant with a mobile communication standard such as Long Term Evolution (LTE), 4th generation (4G), or 5th generation (5G), an interface compliant with a near field communication standard such as Bluetooth (registered trademark), or a LAN interface. The communication unit 12 receives the data used for the operation of the vehicle 10, and transmits the data acquired through the operation of the vehicle 10.

The storage unit 13 includes at least one semiconductor memory, at least one magnetic memory, at least one optical memory, or any combination thereof. Semiconductor memories are, for example, random access memory (RAM) or read only memory (ROM). RAM is, for example, static random access memory (SRAM) or dynamic random access memory (DRAM). ROM is, for example, electrically erasable programmable read only memory (EEPROM). The storage unit 13 functions as, for example, a main storage device, an auxiliary storage device, or a cache memory. The storage unit 13 stores data used for the operation of the vehicle 10 and data acquired by the operation of the vehicle 10. In the present embodiment, the data used for the operation of the vehicle 10 includes a system program, an application program, a database, map information, and the like.

The acquisition unit 14 includes one or more receivers corresponding to any satellite positioning system. For example, the obtaining unit 14 includes a Global Positioning System (GPS) receiver. The acquisition unit 14 acquires the measured value of the position of the vehicle 10 as the position information. The position information includes an address, a latitude, a longitude, an altitude, and the like. The acquisition unit 14 can acquire position information of the vehicle 10. The acquisition unit 14 may constantly acquire the position information of the vehicle 10, or may acquire the position information periodically or non-periodically.

The imaging unit 15 includes an arbitrary imaging module capable of imaging the surroundings of the vehicle 10. For example, the imaging unit 15 includes one or more cameras. Each camera is positioned at an appropriate position of the vehicle 10 so as to be able to capture an image of the surroundings of the vehicle 10. For example, the imaging unit 15 includes a front camera capable of capturing an image of a subject in front of the vehicle 10 or a rear camera capable of capturing an image of a subject behind the vehicle 10. Without being limited to this, the imaging unit 15 may include an omnidirectional camera capable of imaging the entire periphery of the vehicle 10.

The drive unit 16 includes any drive mechanism that enables loading of a load on the vehicle 10, and the transfer of the load loaded on the vehicle 10 to the user, and the unloading of the load loaded on the vehicle 10 to a delivery point. For example, the drive unit 16 includes at least one of an arm mechanism driven by a motor and a slide mechanism capable of linearly sliding a load, and a slide mechanism capable of being taken in and out of the main body of the vehicle 10.

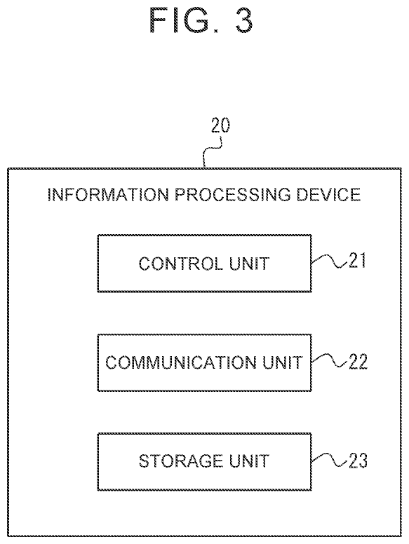

The configuration of the information processing device 20 according to the present embodiment will be described with reference to FIG. 3.

The information processing device 20 includes the control unit 21, the communication unit 22, and a storage unit 23.

The control unit 21 includes at least one processor, at least one programmable circuit, at least one dedicated circuit, or any combination thereof. The processor is a general-purpose processor such as a CPU or a GPU, or a dedicated processor specialized for a specific process. The programmable circuit is, for example, an FPGA. The dedicated circuit is, for example, an ASIC. The control unit 21 executes processes related to the operation of the information processing device 20 while controlling various units of the information processing device 20.

The communication unit 22 includes at least one communication interface. The communication interface supports, for example, a mobile communication standard, a wired LAN standard, or a wireless LAN standard. However, the supported standards are not limited to these, and the communication interface may support any communication standard. The communication unit 22 receives the data used for the operation of the information processing device 20, and transmits the data acquired through the operation of the information processing device 20.

The storage unit 23 includes at least one semiconductor memory, at least one magnetic memory, at least one optical memory, or any combination thereof. The semiconductor memory is, for example, a RAM or a ROM. The RAM is, for example, a static random access memory (SRAM) or a dynamic random access memory (DRAM). The ROM is, for example, an EEPROM. The storage unit 23 functions as, for example, a main storage device, an auxiliary storage device, or a cache memory. The storage unit 23 stores data used for the operation of the information processing device 20 and data acquired through the operation of the information processing device 20. In the present embodiment, the data used for the operation of the information processing device 20 includes a system program, an application program, a database, map information, and the like.

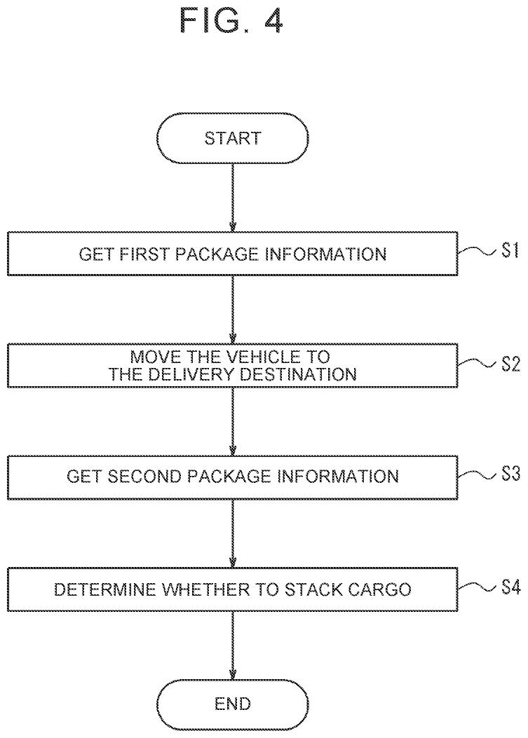

The operation of the vehicle 10 according to the present embodiment will be described with reference to FIG. 4. The operation corresponds to a method according to an embodiment of the present disclosure.

In the present example, it is assumed that a package different from the package related to the current delivery is already disposed at a predetermined delivery point of the delivery destination. However, the present disclosure is not limited to this example. Note that the term “placing” means placing a package pertaining to delivery in a place including an entrance front, a placing bag, a courier box, a garage, or a storage designated in advance by the user.

Step S1: The control unit 11 of the vehicle 10 acquires the first package information regarding the package related to the present delivery.

In this example, it is assumed that the address of the delivery destination, the name of the user, the telephone number and the mail address of the user, and the first package information including the size of the packing box of the package, the weight of the package, or the item name of the package are stored in advance in the storage unit 23 of the information processing device 20. The control unit 11 of the vehicle 10 acquires the first package information from the information processing device 20 via the communication unit 12.

Step S2: The control unit 11 of the vehicle 10 moves the vehicle 10 to the delivery destination based on the address of the delivery destination included in the first package information acquired in the step S1.

In this example, the control unit 11 of the vehicle 10 automatically travels the vehicle 10 to the delivery destination by executing steering control, accelerator control, brake control, and the like of the vehicle 10 using the information acquired by the acquisition unit 14 and the imaging unit 15.

Step S3: The control unit 11 of the vehicle 10 acquires the second package information related to the package that has been placed at the delivery destination.

In the present example, the control unit 11 of the vehicle 10 acquires the second package information including the size or contents of the packing box of the already-placed package, the weight of the package, or the presence or absence of the stack prohibition mark attached to the package or the packing box. Specifically, the control unit 11 of the vehicle 10 determines the size of the packing box or the presence or absence of a stack prohibition mark using an arbitrary image recognition technique from an image of an already placed package or a packing box acquired via the imaging unit 15. Alternatively, the control unit 11 of the vehicle 10 measures the weight of a load that has already been placed using an arbitrary weight sensor, such as placing a load that has already been placed on an arbitrary weight sensor that has already been placed in a delivery point via the drive unit 16. Alternatively, the control unit 11 of the vehicle 10 acquires, via the communication unit 12, information indicating the contents of the already placed baggage stored in advance in the storage unit 23 of the information processing device 20.

Step S4: The control unit 11 of the vehicle 10 determines whether or not to stack the package related to the present delivery on the already-placed package based on the first package information acquired in the step S1 and the second package information acquired in the step S3.

In this example, when the control unit 11 of the vehicle 10 determines that the load that has already been placed is larger and heavier than the load related to the current delivery and that the stack prohibition mark is not affixed on the load that has already been placed, it determines that the load related to the current delivery is stacked on the load that has already been placed. Then, when it is determined to be stacked, the control unit 11 of the vehicle 10 stacks the cargo related to the current delivery on the already placed cargo via the drive unit 16. On the other hand, when it is determined that the packages are not stacked, the control unit 11 of the vehicle 10 places the packages related to the current delivery in the vicinity of the already placed packages or the like via the drive unit 16.

As described above, the control unit 11 of the vehicle 10 according to the present embodiment determines whether or not to stack the cargo based on the package information.

According to such a configuration, even in a case where the space of the delivery point is insufficient, when the package is stacked, a plurality of packages can be placed at the delivery point. Therefore, the efficiency of the placement can be improved.

Although the present disclosure has been described above based on the drawings and the embodiments, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

As a modification, the configuration and operation of the vehicle 10 may be distributed among a plurality of computers capable of communicating with each other. For example, an embodiment in which some of the components of the vehicle 10 are provided in the information processing device 20 is also possible.

Further, as a modification, an embodiment in which a general-purpose computer functions as the information processing device 20 according to the above-described embodiment is also possible. Specifically, a program describing processing contents for realizing each function of the information processing device 20 according to the above embodiment is stored in a memory of the general-purpose computer, and the program is read out and executed by the processor. Therefore, the present disclosure can also be realized as a program that can be executed by the processor or a non-transitory computer-readable medium that stores the program.

A part of the embodiment of the present disclosure is shown as an example below. However, it should be noted that embodiment of the present disclosure is not limited to these.

### APPENDIX 1

A vehicle includes a control unit that determines whether a package is stacked based on package information.

### APPENDIX 2

In the vehicle according to Appendix 1, the package information includes package information on a package that has already been left.

### APPENDIX 3

In the vehicle according to Appendix 1 or 2, the package information includes a size of a packing box of the package, a weight of the package, a content of the packing box, or presence or absence of a stack prohibition mark attached to the package or the packing box.

### APPENDIX 4

In the vehicle according to Appendix 3, the control unit determines the size of the packing box by an image recognition technique.

### APPENDIX 5

In the vehicle according to Appendix 3 or 4, the weight of the package is measured by using a weight sensor installed at a delivery point.

### APPENDIX 6

In the vehicle according to any one of Appendices 3 to 5, the control unit determines the presence or absence of the stack prohibition mark by an image recognition technique.

### APPENDIX 7

In the vehicle according to any one of Appendices 3 to 6, the control unit determines that a package related to current delivery is stacked on a package that has already been left, when the control unit determines that the package that has already been left is larger and heavier than the package related to the current delivery, and the stack prohibition mark is not attached to the package that has already been left.

### APPENDIX 8

A method executed by an information processing device includes determining whether a package is stacked based on package information.

### APPENDIX 9

In the method according to Appendix 8, the package information includes package information on a package that has already been left.

### APPENDIX 10

In the method according to Appendix 8 or 9, the package information includes a size of a packing box of the package, a weight of the package, a content of the packing box, or presence or absence of a stack prohibition mark attached to the package or the packing box.

### APPENDIX 11

The method according to Appendix 10 further includes determining the size of the packing box by an image recognition technique.

### APPENDIX 12

In the method according to Appendix 10 or 11, the weight of the package is measured by using a weight sensor installed at a delivery point.

### APPENDIX 13

The method according to any one of Appendices 10 to 12 further includes determining the presence or absence of the stack prohibition mark by an image recognition technique.

### APPENDIX 14

The method according to any one of Appendices 10 to 13 further includes determining that a package related to current delivery is stacked on a package that has already been left, when determination is made that the package that has already been left is larger and heavier than the package related to the current delivery, and the stack prohibition mark is not attached to the package that has already been left.

### APPENDIX 15

A program that causes a computer to execute functions comprising determining whether a package is stacked based on package information.

### APPENDIX 16

In the program according to Appendix 15, the package information includes package information on a package that has already been left.

### APPENDIX 17

In the program according to Appendix 15 or 16, the package information includes a size of a packing box of the package, a weight of the package, a content of the packing box, or presence or absence of a stack prohibition mark attached to the package or the packing box.

### APPENDIX 18

The program according to Appendix 17 causes the computer to further execute determining the size of the packing box by an image recognition technique.

### APPENDIX 19

In the program according to Appendix 17 or 18, the weight of the package is measured by using a weight sensor installed at a delivery point.

### APPENDIX 20

The program according to any one of Appendices 17 to 19 causes the computer to further execute determining the presence or absence of the stack prohibition mark by an image recognition technique.

What is claimed is:

1. A vehicle comprising a control unit that determines whether a package is stacked based on package information.

2. The vehicle according to claim 1, wherein the package information includes package information on a package that has already been left.

3. The vehicle according to claim 1, wherein the package information includes a size of a packing box of the package, a weight of the package, a content of the packing box, or presence or absence of a stack prohibition mark attached to the package or the packing box.

4. The vehicle according to claim 3, wherein the control unit determines the size of the packing box by an image recognition technique.

5. The vehicle according to claim 3, wherein the weight of the package is measured by using a weight sensor installed at a delivery point.

6. The vehicle according to claim 3, wherein the control unit determines the presence or absence of the stack prohibition mark by an image recognition technique.

7. The vehicle according to claim 3, wherein the control unit determines that a package related to current delivery is stacked on a package that has already been left, when the control unit determines that the package that has already been left is larger and heavier than the package related to the current delivery, and the stack prohibition mark is not attached to the package that has already been left.

8. A method executed by an information processing device, the method comprising determining whether a package is stacked based on package information.

9. The method according to claim 8, wherein the package information includes package information on a package that has already been left.

10. The method according to claim 8, wherein the package information includes a size of a packing box of the package, a weight of the package, a content of the packing box, or presence or absence of a stack prohibition mark attached to the package or the packing box.

11. The method according to claim 10, further comprising determining the size of the packing box by an image recognition technique.

12. The method according to claim 10, wherein the weight of the package is measured by using a weight sensor installed at a delivery point.

13. The method according to claim 10, further comprising determining the presence or absence of the stack prohibition mark by an image recognition technique.

14. The method according to claim 10, further comprising determining that a package related to current delivery is stacked on a package that has already been left, when determination is made that the package that has already been left is larger and heavier than the package related to the current delivery, and the stack prohibition mark is not attached to the package that has already been left.

15. A program that causes a computer to execute functions comprising determining whether a package is stacked based on package information.

16. The program according to claim 15, wherein the package information includes package information on a package that has already been left.

17. The program according to claim 15, wherein the package information includes a size of a packing box of the package, a weight of the package, a content of the packing box, or presence or absence of a stack prohibition mark attached to the package or the packing box.

18. The program according to claim 17, wherein the program causes the computer to further execute determining the size of the packing box by an image recognition technique.

19. The program according to claim 17, wherein the weight of the package is measured by using a weight sensor installed at a delivery point.

20. The program according to claim 17, wherein the program causes the computer to further execute determining the presence or absence of the stack prohibition mark by an image recognition technique.
